(19) United States
(12) Patent Application Publication
(10) Pub. No.: US 2024/0172150 A1
(43) Pub. Date: May 23, 2024

(54) TIME KEEPING AT A WIRELESS DEVICE AND TIME AS A SERVICE BY WIRELESS NETWORKS

(71) Applicant: QUALCOMM Incorporated, San Diego, CA (US)

(72) Inventors: Danlu Zhang, San Diego, CA (US); Bin Tian, San Diego, CA (US); Jiaying Pan, San Diego, CA (US); Bala M. Ramasamy, San Marcos, CA (US)

(21) Appl. No.: 18/058,133

(22) Filed: Nov. 22, 2022

(51) Int. Cl. H04W 56/00

(52) U.S. Cl. CPC H04W 56/0015

(57) ABSTRACT

A wireless device comprising a processor and an internal clock is disclosed, the processor is configured to: run a timer using the internal clock, wherein the timer starts when a first clock-time is acquired from an external source; and when the timer expires, request a second clock-time from a second external source.

### TECHNICAL FIELD

This disclosure relates generally to wireless devices requesting or transmitting time information.

### BACKGROUND

In wireless devices, time information is needed to display it to a user and to properly send and receive data with time stamps. Such a wireless device tracks time using an internal clock. However, if the wireless device only relies on the internal clock, the tracked time starts to drift away from the actual current time. For example in smartwatches (as wireless device), the time is generally only acquired from a paired smartphone. If the smart watch is turned off and/or is not paired to the smartphone for a few weeks, the time diverges from the actual time by hours in error, for some smartwatch models. Such an error in time is a problem. This problem can apply to many different kinds of wireless devices.

### SUMMARY

An example of a wireless device comprises a processor and an internal clock, the processor is configured to: run a timer using the internal clock, wherein the timer starts when a first clock-time is acquired from an external source; and when the timer expires, request a second clock-time from a second external source.

Implementations of such a wireless device include one or more of the following features. The wireless device further comprises a display which is configured to display a message to a user if no second clock-time can be acquired via a wireless connection or if no wireless connection can be established. The wireless device further comprises a battery and the processor is configured to only run the timer when a remaining power of the battery is above a threshold. The processor is configured to set a length of the timer depending on an uncertainty of the first clock-time and/or an uncertainty of the external source. The internal clock is a low power clock; or the wireless device comprises different clocks with different accuracies which are used according to remaining power; or the clock can run in different energy modes. The processor is configured to request the second clock-time using a connection to a smartphone, a cellular network, satellite positioning, an internet connection, or other wireless networks. The processor is configured to select the connection depending on an environment of the wireless device. The wireless device is a smart watch. The external source and the second external source are the same external source. The external source and the second external source are different external sources. The processor is further configured to, when the second clock-time can not be acquired from the second external source, request the second clock-time from a third external source which is different to the second external source.

An example of a method for keeping time comprises: running a timer using an internal clock, wherein the timer starts when a first clock-time is acquired from an external source; and requesting a second clock-time from a second external source when the timer expires.

Implementations of such a method may include one or more of the following features. The method further comprises displaying a message to a user if no second clock-time can be acquired via a wireless connection or if no wireless connection can be established. The method further comprises setting a length of the timer depending on an uncertainty of the first clock-time or an uncertainty of the external source. The method further comprising setting a clock to an energy mode depending on an energy level. The method further comprises, when the second clock-time can not be acquired from the second external source, requesting the second clock-time from a third external source which is different to the second external source.

An example of a computer program product comprises instructions which, when the program is executed by a computer, cause the computer to carry out the above mentioned method.

An example of an apparatus for keeping time, comprises: means for running a timer, wherein the timer starts when a first clock-time is acquired from an external source; and means for requesting a second clock-time from a second external source when the timer expires.

An example of a wireless unit is configured to: receive a request for time information from a wireless device; and transmit a signal to the wireless device, the signal comprising the time information in response to the request for the time information.

Implementations of such a wireless unit may include one or more of the following features. The wireless unit may be further configured to transmit the signal comprising time information regardless of a user subscription and/or an authentication from the wireless device from which the request is received. The request is received and the signal is transmitted via a wireless connection between the wireless unit and the wireless device. The wireless unit and the wireless device are both wireless access points, APs. The wireless device is further configured to calculate time delay of the request or the signal. The wireless unit is a cellular network AP and the request is received and the signal is transmitted via a random access channel.

An example of a method for transmitting time information, comprises: receiving, by a wireless unit, a request for the time information from a wireless device; and transmitting, by the wireless unit, a signal to the wireless device, the signal comprising the time information in response to the request of the time information.

Implementations of such a method may include one or more of the following features. The transmitting the signal comprising time information is done regardless of a user subscription and/or an authentication from the wireless device from which the request is received. The requesting is received and the signal is transmitted via a wireless connection between the wireless unit and the wireless device. The method further comprises calculating, by the wireless device, a time delay of the request and/or the signal.

An example of a computer program product comprises instructions which, when the program is executed by a computer, cause the computer to carry out the above mentioned method.

An example of an apparatus for transmitting time information, comprises: means for receiving a request for time information; and means for transmitting a signal comprising the time information in response to the request for the time information.

Methods and apparatus according to this disclosure supports a wireless device to correct and check its internal clock or at least warn a user of the wireless device of a high risk of a wrong time.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF DRAWINGS

For a more complete understanding of the present disclosure, reference is now made to the following description taken in conjunction with the accompanying drawings.

FIG. 1 shows a block diagram of a wireless device with external sources.

FIG. 2 shows a block diagram of an exemplary wireless device.

FIG. 3 shows a smart watch with external sources.

FIG. 4 shows a process flow diagram of a method for keeping time.

FIG. 5 shows a process flow diagram for exemplary steps for one step of FIG. 4.

FIG. 6 shows a process flow diagram for an example of an implementation of the method of FIG. 4.

FIG. 7 shows a message flow diagram for example messages between a wireless device and external sources.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

As described, the use of the term “and/or” is intended to represent an “inclusive OR”, and the use of the term “or” is intended to represent an “exclusive OR”. The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

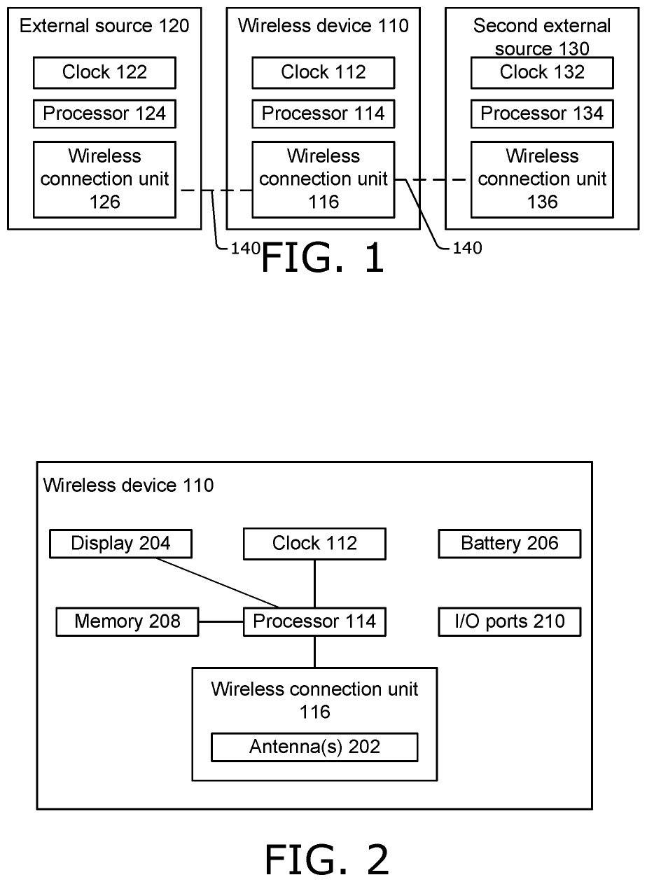

FIG. 1 illustrates an example system comprising a wireless device 110 with an external source 120 (also first external source) and a second external source 130. The wireless device 110 comprises a clock 112, a processor 114, and a wireless connection unit 116. The (first) external source 120 comprises a clock 122, a processor 124, and a wireless connection unit 126. The second external source 130 comprises a clock 132, a processor 134, and a wireless connection unit 136. There can be further units in one or more of the wireless device 110 and the first and second external source 120, 130. There can be wireless connections 140 between the wireless connection unit 116 of the wireless device 110 and one or both of the wireless connection units 126, 136 of the first and second external sources 120, 130 illustrated by the dashed lines in FIG. 1.

The wireless device 110 may correspond to a smartwatch, cellphone, smartphone, laptop, tablet, PDA, tracking device or some other portable or moveable device. Typically, though not necessarily, a wireless device may support wireless communication such as using GSM, WCDMA, LTE, CDMA, HRPD, WiFi, BT, WiMax etc. A wireless device may be a single entity or may comprise multiple entities such as in a personal area network where a user may employ audio, video and/or data input/output (I/O) devices and/or body sensors and a separate wireline or wireless modem. The wireless device 110 may be a user device or user equipment which is able to transmit and receive wireless signals. The wireless device 110 may not need to constantly receive power from an external power supply. An exemplary wireless device is also described below regarding FIG. 2.

The first external source 120 and the second external source 130 (respectively or both) may exemplarily be one of a mobile device (like a smartphone), a wireless (/WIFI) router, an access point (AP) for example for mobile (data) connection, a network access point, a Bluetooth beacon, satellite (for example for satellite positioning system (SPS)), a computer, a personal computer, a smartwatch, or another wireless transceiver.

The wireless connection(s) 140 (respectively or both) may be a Bluetooth connection, a WIFI connection, a cellular network connection, a near-field communication (NFC) connection, or another wireless connection. The wireless connection(s) 140 (respectively or both) may be a standing connection which stands for a long time or it may be established, for example established on an initiative of the wireless device 110.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000 or Wideband-CDMA (“W-CDMA”). Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks and and/or 5G communication networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

The clock 112 (of the wireless device 110) is a unit which keeps an internal time or at least helps in keeping the internal time. The internal time shall at best be the same as the current time. Current time (sometimes also called “actual current time”) in the context of the current disclosure is the time presented by a watch or clock when the watch or clock is correct. In this manner the current time is connected to the coordinated universal time or UTC (but may vary depending on the time zone and potential summer time). The current time may comprise the time of the day (for example in hours and minutes seconds, and smaller units) as well as the date (day of month and month) and year. The clock 112 may provide the internal time in the same form as the current time can be presented. Alternatively, the clock 112 may provide a clock signal with which the internal time can be kept. In embodiments, it is possible that the clock 112 is a low power clock, that the wireless device 110 comprises more than one clock, or that the wireless device 110 comprises the clock 112 can run in different energy modes. In the embodiment of more than one clock, each clock may have a different consumption of power and have a different accuracy. Depending on remaining energy of a battery of the wireless device 110, a clock with higher accuracy and power consumption (when more energy is left in the battery) or lower accuracy and power consumption (when little energy is left in the battery) might be used. There may be thresholds of remaining energy in the battery for the selection of the clock to use. In the embodiment of the single clock 112 having different energy modes, the clock 112 has energy modes which consume more energy and have a higher accuracy and different modes which consume less energy and have a lower accuracy. These different energy modes may be used depending on remaining energy in the battery (higher energy consumption when more energy is left and lower energy consumption when less energy is left). The energy level may be selected based on energy thresholds in the battery. Alternatively, the selection from the power mode or the selection from the more than one clock can depend whether the wireless device is turned on, off, or in stand by.

In this disclosure, the word accuracy is used for both: accuracy and precision. When high or low accuracy is discussed, this can mean that accuracy and precision are high/low or that one of accuracy and precision are high/low. A time of a clock with low accuracy (and/or precision) will deviate more quickly from the actual current time.

The processor 114 (of the wireless device 110) may be the main operating part in the wireless device 110. It may implement the methods disclosed herein. It may be connected to the other parts of the wireless device 110 via a bus system.

The wireless connection unit 116 (of the wireless device 110) may comprise one or more antennas 202 as shown in FIG. 2. The wireless connection unit 116 can transmit and receive wireless signals via one or more wireless connections 140. The wireless connection unit 116 may be capable of receiving and transmitting at least one kind of possible signal mentioned for the wireless connection 140 above. The wireless connection unit 116 may be able to maintain one wireless connection or more than one wireless connection at a time. Some embodiments may include multiple wireless connection units and wireless antennas to enable transmitting and/or receiving signals according to corresponding multiple wireless communication standards such as, for example, versions of IEEE Std. 802.11, CDMA, WCDMA, LTE, UMTS, GSM, AMPS, Zigbee and Bluetooth.

The clocks 122, 132, the processors 124, 134, and the wireless connection units 126, 136 of the first and second external source 120, 130 can show basically the same properties and features as described for the corresponding parts of the wireless device 110 above. The person skilled in the art will understand how the first and second external source 120, 130 need to be adapted.

FIG. 2 illustrates an exemplary wireless device 110, which may also be the wireless device 110 shown in FIG. 1. The wireless device 110 may further comprise a display 204, a battery 206, a memory 208, and one or more input/output (I/O) ports 210. Further, the wireless connection unit 116 may comprise one or more antennas 202.

The display 204 may show a time to a user. It may further show messages and warnings to the user. The display 204 may be several displays. The display(s) 204 may be integrated into the wireless device 110 and/or may be coupled to the wireless device 110. Examples of the display(s) 204 include liquid crystal display (LCD) screens, light emitting display (LED) screens, organic light emitting display (OLED) screens, plasma screens, cathode ray tube (CRT) screens, etc. In some implementations, the wireless device 110 may be a smartphone or smartwatch with an integrated display. In another example, the wireless device 110 may be linked to one or more remote displays 204 and/or to one or more remote devices that include one or more displays 204.

The battery 206 may store energy so that the wireless device 110 can work without a connection to an external energy source. The battery 206 may be a battery only powering the clock 112 (in this case there may be another battery powering the wireless device 110), or the battery 206 may be a battery powering the entire wireless device 110.

The memory 208 may be a computer readable storage medium (CRM). The processor 114 may execute processor-executable code stored by the CRM. The CRM can include any suitable type of data storage media, such as volatile memory (e.g., random access memory (RAM)), non-volatile memory (e.g., Flash memory), optical media, magnetic media (e.g., disk), and so forth. In the context of this disclosure, the CRM is implemented to store instructions, data, and other information of the wireless device 110.

The I/O ports 210 enable data exchanges or interaction with other devices, networks, or users. The I/O ports 210 may include serial ports (e.g., universal serial bus (USB) ports), parallel ports, audio ports, infrared (IR) ports, user interface ports such as a touchscreen, and so forth

The wireless device 110 may further comprise digital signal processor(s) (DSP(s)) (not shown) connected to a bus by a bus interface (as possible for all parts of the wireless device 110), general-purpose processor(s) 114 connected to the bus by the bus interface and memory 208. Bus interface may be integrated with the DSP(s), general-purpose processor(s) 114 and memory 208. In various embodiments, functions may be performed in response to execution of one or more machine-readable instructions stored in memory 208 such as on a computer-readable storage medium, such as RAM, ROM, FLASH, or disc drive. The one or more instructions may be executable by general-purpose processor(s) 114, specialized processors, or DSP(s). Memory 208 may comprise a non-transitory processor-readable memory and/or a computer-readable memory that stores software code (programming code, instructions, etc.) that are executable by processor(s) 225 and/or DSP(s), and/or other processor(s) to perform functions described herein.

The wireless device 110 may further comprise a user interface which may comprise any one of several devices such as, for example, a speaker, a microphone, a display device (including the display 204), a vibration device, a keyboard, and/or a touch screen. In a particular implementation, user interface may enable a user to interact with one or more applications hosted on mobile device. For example, devices of user interface may store analog or digital signals on memory 208 to be further processed by DSP(s) or general purpose processor 114 in response to action from a user. Similarly, applications hosted on the wireless device 110 may store analog or digital signals on memory 208 to present an output signal to a user. In another implementation, wireless device 110 may optionally include a dedicated audio input/output (I/O) device comprising, for example, a dedicated speaker, microphone, digital-to-analog circuitry, analog-to-digital circuitry, amplifiers and/or gain control. This, however, is merely an example of how an audio I/O may be implemented in a wireless device, and claimed subject matter is not limited in this respect. Wireless device 110 may comprise touch sensors responsive to touching or pressure on a keyboard or touch screen device.

Wireless device 110 may also comprise a dedicated camera device for capturing still or moving imagery. Camera device may comprise, for example, an imaging sensor (e.g., charge coupled device or CMOS imager), lens, analog to digital circuitry, and frame buffers. Additional processing, conditioning, encoding or compression of signals representing captured images may be performed at general purpose/application processor 114 or DSP(s). A dedicated video processor may perform conditioning, encoding, compression or manipulation of signals representing captured images. A video processor may decode/decompress stored image data for presentation on a display device on wireless device 110.

Wireless device 110 may also comprise sensors coupled to a bus which may include, for example, inertial sensors and environment sensors that may enable wireless device 110 to determine relative changes in location and/or current speed and heading. Inertial sensors of sensors may comprise, for example accelerometers (e.g., collectively responding to acceleration of wireless device 110 in three dimensions), one or more gyroscopes or one or more magnetometers (e.g., to support one or more compass applications). Environment sensors of wireless device 110 may comprise, for example, temperature sensors, barometric pressure sensors, ambient light sensors, camera imagers, or microphones. Sensors may generate analog or digital signals that may be stored in memory 208 and processed by DPS(s) or general purpose application processor in support of one or more applications such as, for example, applications directed to positioning or navigation operations.

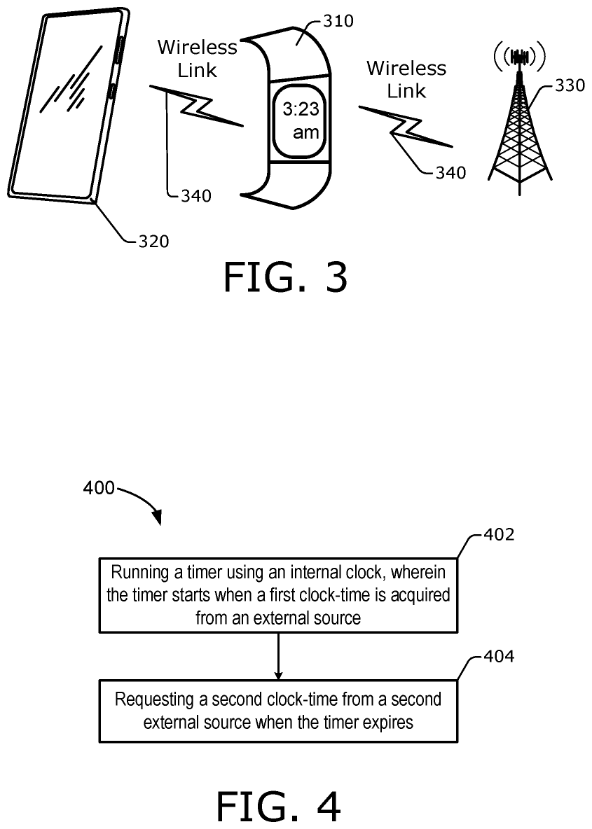

FIG. 3 illustrates an example of the system of FIG. 1. In the case of FIG. 3, the wireless device 110 is a smartwatch 310, the external source 120 is a smartphone 320, and the second external source 130 is a wireless AP 330. Further, the wireless connections 340 (equal to wireless connections 140) are depicted as arrows. A display (204) of the smartwatch shows a time (3:23 am).

If the smart watch 310 did not receive time information (like the current time) for a while, the time showing on the display may deviate from the actual current time, as explained above. This can also apply for other wireless devices 110. To prevent this, the method 400 illustrated in FIG. 4 can be implemented.

The method 400 comprises the steps 402 and 404. Method 400 may be implemented by the wireless device 110 (or the processor 114 of the wireless device 110). In step 402, a timer is run using an internal clock 112, wherein the timer starts when a first clock-time is acquired from an external source 120.

When the wireless device 110 acquires a first clock-time from the external source 120, the wireless device 110 may correct the internal clock with the first clock-time or replace the internal time with the first clock-time (or at least compare the times). The clock-time is a time information comprising the current time or at least an internal time from the external source 120 which has a high accuracy (probably only deviating from the current time by less than 5 seconds, or less than one second, or by a few ms). If not stated differently, the terms clock-time and time information are used for the same meaning. From then on the wireless device 110, with the help of the clock 112, keeps the time up to date (or tries to do so as good as possible). During a time in that no new time information is received, the wireless device 110 can only rely on the internal clock 112 to keep the time. Due to the lack of accuracy of the clock 112, the internal time of the wireless device 110 may deviate from the actual current time. Generally, this deviating grows over time. In this manner, the length of the timer represents a duration in which the deviating generally does not grow to grave.

The timer can be a duration which runs down like a stop watch. When the timer is run down to zero (0) it is expired. It is also possible that the timer is like an alarm clock 112. When the timer is started (to run), a end time of the timer is set. When the internal clock reaches this end time, the timer is expired. The duration of the timer is generally in the order of hours or days. The duration can exemplarily be 6 hours, 12 hours, 1 day (24 hours), 2 days, 7 days, or a different duration. The time may run down with the time (or the clock signal) of the internal clock 112.

In step 404, a second clock-time is requested from a second external source 130 when the timer expires.

When the timer expires, the wireless device 110 tries to acquire time information from the outside (second external source 130). This second external source 130 may be a source as explained above, the same source as the first external source 120, or a user input for example via a touch screen. The request of the second clock-time may comprise one or more of requesting or setting up a connection to the second external source 130, sending a request for time information, displaying a message that the internal time might deviate gravely from the actual current time, and requesting the user to input time information.

The wireless device 110 may only implement the time and therewith the method 400, when the remaining energy in the battery 206 exceeds an energy threshold.

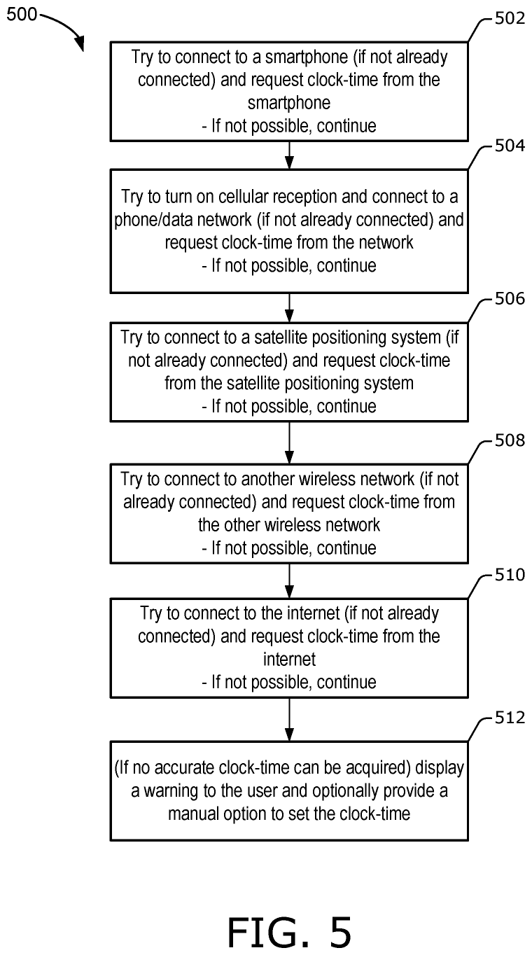

FIG. 5 illustrates an exemplary implementation method 500 of the step 404. The steps 502 to 510 require the capability of the wireless device 110 to set up different kinds of wireless connections. Individual steps of these steps 502 to 510 can be omitted if the wireless device 110 implementing this method 550 is not capable of connecting in such a way or individual steps can be amended to other wireless connection kinds which the wireless device 110 can have. The method 500 may be implemented by the wireless device 110.

In step 502, it is tried to connect to a smartphone (if not already connected) and a clock-time is requested from the smartphone. If this is not possible, the method proceeds to the next step.

When the timer expires the wireless device 110 may check whether a connection to a smartphone is still active. If the connection is not active, the wireless device 110 may try to build up a connection to the smartphone. If the connection to the smartphone stands (because it still stands or because it was successfully build up), the wireless device 110 may request a clock-time from the smartphone. If this is successful, the method step 404 (the method shown in FIG. 5) may stop here. The wireless device 110 may reset the timer. In this manner, the method 400 can repeat itself to keep the internal time from deviating too much. If the wireless device did not successfully acquire a (second) clock-time from the smartphone, it may proceed to the next step 504.

In step 504, it is tried to turn on cellular reception and to connect to a phone/data network (if not already connected) and a clock-time is requested from the network. If this is not possible, the method proceeds to the next step.

The wireless device 110 turns its capability to receive and transmit mobile data on, if not already on. The wireless device 110 may check whether a connection to the mobile data AP is still active, if not already connected. If the connection is not active, the wireless device 110 may try to build up a connection to the mobile data AP. If the connection to the mobile data AP stands (because it still stands or because it was successfully build up), the wireless device 110 may request a clock-time from the mobile data AP. If this is successful, the method step 404 (the method shown in FIG. 5) may stop here. The wireless device 110 may reset the timer. In this manner, the method 400 can repeat itself to keep the internal time from deviating too much. If the wireless device did not successfully acquire a (second) clock-time from the mobile data AP, it may proceed to the next step 506. If the wireless device 110 is in airplane mode, a user permission may be acquired. This user permission may be acquired using a message on the display 204.

In step 506, it is tried to connect to a satellite positioning system (if not already connected) and a clock-time is requested from the satellite position system. If this is not possible, the method proceeds to the next step.

Instead of trying to connect to the satellite position system, it can be tried to connect to a satellite instead; or instead of connecting to the satellite position system, it can be connected to a satellite instead. The wireless device 110 turns its capability to receive and transmit to a satellite positioning system on, if not already on. The wireless device 110 may check whether a connection to the satellite positioning system is still active, if not already connected. If the connection is not active, the wireless device 110 may try to build up a connection to the satellite positioning system. If the connection to the satellite positioning system stands (because it still stands or because it was successfully build up), the wireless device 110 may request a clock-time from the satellite positioning system. If this is successful, the method step 404 (the method shown in FIG. 5) may stop here. The wireless device 110 may reset the timer. In this manner, the method 400 can repeat itself to keep the internal time from deviating too much. If the wireless device did not successfully acquire a (second) clock-time from the satellite positioning system, it may proceed to the next step 508. The wireless device 110 may not acquire position information from the satellite positioning system. It is sufficient to receive time information from the satellite positioning system. Therefore, the wireless device 110 may only have a wireless connection to one satellite. The wireless device 110 may only build up the connection to the satellite if a remaining energy in the batter 206 exceeds a higher threshold (for example higher than the thresholds to implement method 400). This saves energy because power consumption for connecting to a satellite is high.

In step 508, it is tried to connect to another wireless network (if not already connected) and a clock-time is requested from the other wireless network. If this is not possible, the method proceeds to the next step.

The wireless device 110 turns its capability to receive and transmit from one or more other wireless networks on, if not already on. The wireless device 110 may check whether a connection to the one or more other wireless networks is still active, if not already connected. If the connection is not active, the wireless device 110 may try to build up a connection to the one or more other wireless networks. If the connection to the one or more other wireless networks stands (because it still stands or because it was successfully build up), the wireless device 110 may request a clock-time from the one or more other wireless networks. If this is successful, the method step 404 (the method shown in FIG. 5) may stop here. The wireless device 110 may reset the timer. In this manner, the method 400 can repeat itself to keep the internal time from deviating too much. If the wireless device did not successfully acquire a (second) clock-time from the one or more other wireless networks, it may proceed to the next step 510.

In step 510, it is tried to connect to the internet (if not already connected) and a clock-time is requested from the internet. If this is not possible, the method proceeds to the next step.

The wireless device 110 turns its capability to receive and transmit from the internet on, if not already on. The wireless device 110 may check whether a connection to the internet is still active, if not already connected. If the connection is not active, the wireless device 110 may try to build up a connection to the internet. If the connection to the internet stands (because it still stands or because it was successfully build up), the wireless device 110 may request a clock-time from the internet. If this is successful, the method step 404 (the method shown in FIG. 5) may stop here. The wireless device 110 may reset the timer. In this manner, the method 400 can repeat itself to keep the internal time from deviating too much. If the wireless device did not successfully acquire a (second) clock-time from the internet, it may proceed to the next step 510.

In step 512, a warning is displayed to the user and optionally a manual option to set the clock-time is provided, if no accurate clock-time can be acquired otherwise.

If the wireless device 110 did not succeed in acquiring a second clock-time by any (potential) wireless connection in an automatic way, it may display a warning (/message) on its display 204. This warning provides information to the user that there is an elevated risk of the internal time of the wireless device 110 deviating gravely from the actual current time. Additionally or alternatively, the wireless device 110 may request the user to input time information manually and thereby the wireless device 110 can acquire a (second) clock-time. Such time information acquired from the user is often not as accurate as time information from an electronic source (for example acquired by one of the steps 502 to 510). Hence, the wireless device 110 may set a new timer when the time from the user is acquired, wherein the new timer has a shorter duration than the timer of step 402. The wireless device 110 may also or alternatively display a list in the warning. The list may comprise possible wireless connections through which the second clock-time can be acquired. This list may comprise the option to acquire time from a satellite, especially when such a connection was not there and/or not build up in step 506. Further, the wireless device 110 may prompt the user to allow and/or enable one or more of the wireless connections on the list (also comprising satellite connection, especially when not tried in step 506). This can exemplarily be done by the user by allowing and/or enabling the Bluetooth function (and/or other functions like mobile data, WIFI, GNSS, and so on) on the wireless device 110.

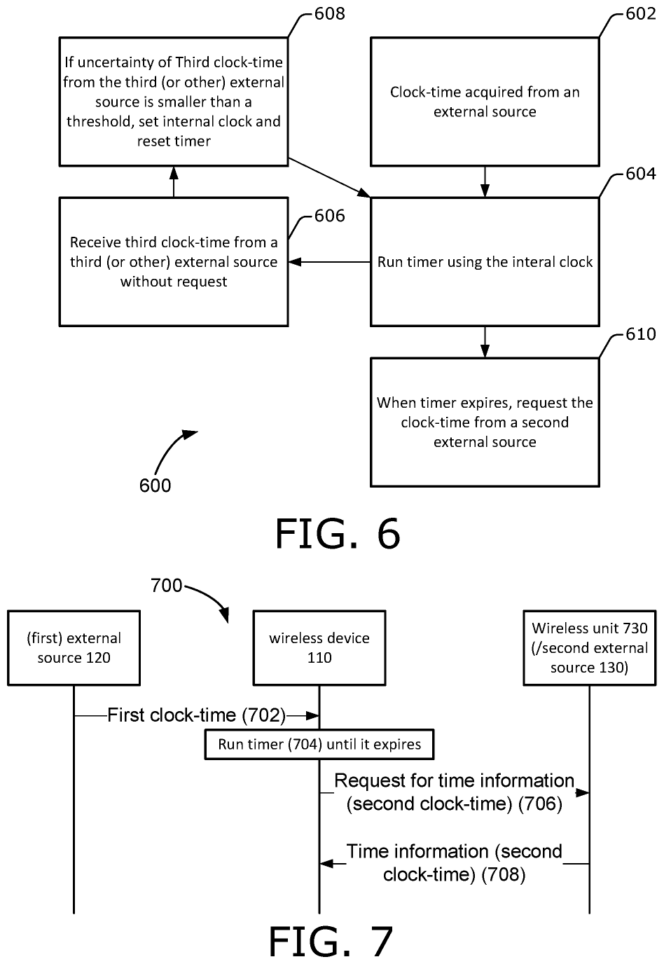

FIG. 6 illustrates an aspect of the method 400. In this aspect the timer is reset when time information is received by the wireless device 110.

In step 602, the wireless device 110 acquires a clock-time from an external source and in step 604, the wireless device 110 runs a timer using the internal clock 112. These steps 602 and 604 mostly correspond to step 402. The person skilled in the art is able to compare these steps from the two Figures.

In step 610, the wireless device 110 request a (second) clock-time from a second external source when the timer expires. This step 610 mostly corresponds to step 404. The person skilled in the art is able to compare these steps.

In step 606 the wireless device 110 receives a third clock-time from a third (or other) external source without request. This may happen when the wireless device 110 receives time information without requesting it (before the timer expires). For example, the smartphone 320 of FIG. 3 may transmit time information to the smartwatch 310 without the smartwatch 310 requesting it.

The wireless device 110 may directly use the received time information to correct the internal time and reset the timer and return to step 604. Alternatively, the wireless device 110 may proceed to step 608.

In step 608, the internal clock 112 is set and the timer is reset if the uncertainty of the third clock-time from the third (or other) external source is smaller than a threshold.

In this step, the wireless device 110 checks how accurate the unrequested time information is. The information about the accuracy (opposite of uncertainty) of the time information may be part of the time information, it may be received separate from the time information from the same external source 120, 130, it may be received from a different external source than the time information, and/or it may be known (before) by the wireless device 110. In the last alternative, the wireless device 110 may have a register or table which matches an accuracy value (or a range of the accuracy value) to each external source and/or each type of external source (types like smartphone, WiFi, satellite, etc.). For example, time information of a satellite may be very high, while the information from a manual input of a user may be low, and time information from WiFi may be accurate.

The wireless device 110 may compare the accuracy to a threshold. This threshold may be a constant and predefined threshold, or it may be a variable threshold. If the threshold is variable, it may be based on the (previous acquired) time information on which the current internal time is based (from last time the internal clock was corrected/compared; short: previous used time information). It may be based in such a way that the accuracy of the previous used time information, the length of how much of the timer is already run down, an accuracy of the internal clock (signal) (for example caused by a drift of the internal clock), and/or other values are used to calculate the variable threshold.

In one example, the variable threshold is lower when the previous used time information has a low accuracy, and/or when the time is closer to expiry, and/or when the internal clock has a low accuracy. In this example the variable threshold is higher when the previous used time information has a high accuracy, and/or when the time has only run down a small part of its duration, and/or when the internal clock has a high accuracy. A low variable threshold means that the accuracy of the new time information can be relatively low and will be used to correct/compare the internal time. A high variable threshold means that a new time information with a low or average accuracy will be discarded and the internal clock will not be changed. All this can prevent the internal time from being deteriorated by the new time information.

It is also possible that the (new) timer duration is adapted based on the accuracy of the new time information (if correcting the internal clock). If the new time information has a low accuracy, the new timer has a smaller duration. If the new time information has a high accuracy, the new timer has a higher duration. This can increase accuracy of the internal time in the future.

The decision whether to correct/compare the internal time with the new time information may also be based on a target error tolerance. The internal time may only be corrected/compared if the accuracy of the internal time is bigger than the target error tolerance and/or if the accuracy of the new time information is smaller than the target error tolerance. The target error tolerance may be in the order of a few seconds for daily use. It is possible that a warning/message to the user includes an error range of the accuracy of the internal time.

The wireless device 110 may also consider the operation when it is powered off. The wireless device 110 may keep a low power clock on when the wireless device 110 is turned off. For this the accuracy of the internal time may be adjusted. This can help to consider a potentially higher time drift of the low power clock. If the clock 112 is out of power and the operation of the (low power) clock 112 can not be maintained anymore, or if the timer expires while the wireless device 110 is turned off (when no wireless connection can be established to acquire time information), a status flag may be written in a non-volatile memory. This may lead to the wireless device 110 implementing step 404 and/or method 500 and/or method 600 when the wireless device 110 is turned on again. The timer in power off mode may vary to the timer when the wireless device 110 is not turned off.

The wireless device 110 may also include situational awareness and act accordingly. When the wireless device 110 is in airplane mode, it may refrain from using WiFi and cellular (and other connections) to acquire time information and rather directly display a warning/message to the user (or rely on possible connections like Bluetooth and NFC). Even if the wireless device 110 is not in the airplane more, it may detect that it is in flight. This may be detected by signs like continuous search failure, cabin pressure measurements, and so on (and/or by use of the environment sensors). When the wireless device 110 detects that it is in flight, it may display a(n according) warning/message to the user. Not trying to build up wireless connection can save power. Therefore, trying to build up wireless connection while in flight/airplane mode may only be done when sufficient energy is left in the battery 206.

FIG. 7 illustrates a message flow diagram for example messages between the wireless device 110 and the external sources 120, 130 (wherein the second external source 130 may be the same as the wireless unit 730). A message in step 702 comprises the first clock-time and is transmitted from the first external source 120 to the wireless device 110. This may also be part of method step 402. When the wireless device 110 receives the first clock-time, it runs a timer which is shown in box 704. When the timer expires, the wireless device 110 proceeds with step 706. In step 706, the wireless device 110 requests time information (which may be the same as the second clock-time) from a wireless unit 730 (which may be the same as the second external source 130). Step 706 may be comprised by step 404. As a response, the wireless unit 730 transmits a signal comprising the time information to the wireless device 110. This is shown in step 708.

From the view of the wireless unit 730, this looks as follows: In step 706, the wireless unit 730 receives the request for time information from the wireless device 110. In response to the request for the time information, the wireless unit 730 transmits a signal to the wireless device 110, wherein the signal comprises the time information (step 708). This concept shall be called “time as a service”.

In time as a service, a wireless device 110 can get time information from a wireless unit on demand. In this manner, a wireless device 110 can correct (or at least check) its internal clock-time whenever the wireless device 110 itself sees it fit (for example when die timer expires or when the wireless device 110 is reset). The wireless device 110 may initiate the time as a service process and the wireless unit 730 may respond. Time as a service can work especially efficient if it is implemented as a standard for specific devices. Then, wireless devices 110 may request time from many different wireless units 730, when the wireless device 110 is at different places.

The wireless unit 730 may exemplarily be one of a mobile device, a wireless (/WIFI) router, an access point (AP) for example for mobile (data) connection, a network access point, a Bluetooth beacon, satellite (for example for satellite positioning system), a computer, a personal computer, or another wireless transceiver.

The request for time information in step 706 and/or the transmitting of the time information in step 708 may be direct. This means that the packets are not forwarded by the wireless unit 730 to another node or server. This provides a local solution which can be simpler.

Time as a service may not require that the wireless device 110 has a (user) subscription and/or authentication with the wireless unit 730 or the service provided over the wireless unit 730. In one example when the wireless unit 730 is a WIFI router (an AP or another type) and the wireless device 110 is capable to connect to WIFI routers, the wireless device 110 would not need to be registered in the wireless network of the WIFI router. It is not necessary that the wireless device 110 is connected to the internet via the WIFI router. However, the wireless device 110 can still send a request for time information to the WIFI router and the WIFI router would transmit a signal with time information in response. In one example, where the wireless unit 730 is a IEEE 802.11 device (like a router or a beacon), the time information can be added as an optional field. In another examples, it is possible that the request-response procedure of the time as a service (as shown for steps 706 and 708 above) is added to Bluetooth or other wireless local networks.

In another example, the wireless unit 730 can be a router (or AP or other type) of another technology (like Bluetooth or another wireless network, including wireless local networks). Accordingly, the wireless connection is of this technology too. In one example using a cellular network, the time information may be transmitted in System Information Broadcast, for example in SIB9 (system information block) in 5G. An example how such a SIB9 can be structured is show in the following table:

| SIB9 | |
|---|---|
| timeInfo | |
| timeInfoUTC | INTEGER (0 . . . 549755813887) |
| dayLightSavingTime | BIT STRING (SIZE (2)) |
| leapSeconds | INTEGER (−127 . . . 128) |
| localTimeOffset | INTEGER (−73 . . . 74) |

In one example, time as a service is implemented for cellular networks, wherein no (user) subscription is needed for providing time information on demand. A wireless device 110 may request the time information in a Random Access Message (RACH). This may be implemented by adding a new field to msg3 in regular 4-step RACH in Rel. 15 NR or in 2-step RACH in Rel. 17 NR. The network (the wireless unit 730) may reply to the request in Random Access Response. This response may contain the same information as the SIB9 shown above. With no (user) subscription, no RRC (radio resource control) is needed. This is feasible because all data exchange happens within RACH processes.

In another example, the wireless device 110 being a smartwatch may request time information from another smartphone as wireless unit 730 to which it is not fully connected (in the meaning of being not fully paired or not being subscribed; “other” smartphone as other to the smartphone to which the smartwatch is fully linked). Still the smartwatch and the other smartphone see (meaning to be able to connect to each other) each other and the other smartphone may transmit time information to the smartwatch, when the other smartphone supports time as a service. This request and transmitting of time information may be, for example, transmitted through a 5G sidelink, WiFi direct, normal WiFi, or other wireless connections.

In one example, there may be further condition(s) for the wireless unit 730 to transmit the time information in response to the request for time information from the wireless device 110. Such a condition may be that the wireless device 110 is able to fully enter the network of the wireless unit 730. This may be, for example, that the wireless device 110 comprises a SIM card which allows access to the (cellular) network of the wireless unit 730. An alternative may be that the cellular network operator (or the wireless unit 730) can treat the request for time information in a manner similar to emergency service wherein all such inquiries/requests will be answered regardless of the user subscription (this alternative may be adapted to any kind of wireless connection). In either way, it then may not be necessary for the wireless device 110 to fully connect to the network of the wireless unit 730. This condition may be checked by the wireless unit 730 when the request for time information is received. A provider of the network of the wireless unit 730 may not charge money for the time as a service. The free time as a service may only be provided for wireless devices 110 which has a general service (user) subscription (as for example a SIM card which allows access to the cellular network of the provider or possible business partners of the provider). This may give potential providers of time as a service an economical motivation to implement time as a service.

Another condition may be that only a certain number of time information requests (per unit time) are being served. This may, for example, be implemented in WiFi networks/WiFi APs. This can prevent the wireless unit 730 from being overwhelmed or attacked. One embodiment is that a user does not need any association with the WiFi access point. For example, its time information request will be answered without any need of password for accessing the AP (or other type of user subscription or authentication).

If the wireless unit 730 is a user device, a consent of the user of the wireless unit 730 may be needed as a condition. This can be of mutual benefit for the users.

The system may further follow security procedures as for example implemented in the CV2X security procedure based on IEEE1609.2. This may be implemented for cellular, WiFi, and/or other solutions. This can improve the security.

Techniques described herein may be used with a satellite positioning system (“SPS”) that includes any one of several global navigation satellite systems (“GNSS” such as the Global Positioning system “GPS”, the Russian GLONASS system and the European Union's Gallileo system and the Chinese BeiDou and BeiDou-2 systems) and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

Example embodiments may include one or more of the following clauses.

1. A wireless device comprising a processor and an internal clock, the processor configured to:
run a timer using the internal clock, wherein the timer starts when a first clock-time is acquired from an external source; and
when the timer expires, request a second clock-time from a second external source.

2. The wireless device of clause 1, wherein the wireless device further comprises a display which is configured to display a message to a user if no second clock-time can be acquired via a wireless connection or if no wireless connection can be established.

3. The wireless device of any of the preceding clauses, wherein the wireless device further comprises a battery and the processor is configured to only run the timer when a remaining power of the battery is above a threshold.

4. The wireless device of any of the preceding clauses, wherein the processor is configured to set a length of the timer depending on an uncertainty of the first clock-time or an uncertainty of the external source.

5. The wireless device of any of the preceding clauses, wherein the internal clock is a low power clock; or
wherein the wireless device comprises different clocks with different accuracies which are used according to remaining power; or
wherein the clock can run in different energy modes.

6. The wireless device of any of the preceding clauses, wherein the processor is configured to request the second clock-time using a connection to a smartphone, a cellular network, satellite positioning, an internet connection, or other wireless networks.

7. The wireless device of clause 6, wherein the processor is configured to select the connection depending on an environment of the wireless device.

8. The wireless device of any of the preceding clauses, wherein the wireless device is a smart watch.

9. The wireless device of any of the preceding clauses, wherein the external source and the second external source are the same external source.

10. The wireless device of any of the preceding clauses, wherein the external source and the second external source are different external sources.

11. The wireless device of any of the preceding clauses, wherein the processor is further configured to, when the second clock-time can not be acquired from the second external source, request the second clock-time from a third external source which is different to the second external source.

12. A method for keeping time, the method comprising:
running a timer using an internal clock, wherein the timer starts when a first clock-time is acquired from an external source; and
requesting a second clock-time from a second external source when the timer expires.

13. The method of clause 12, further comprising displaying a message to a user if no second clock-time can be acquired via a wireless connection or if no wireless connection can be established.

14. The method of any of the clauses 12 and 13, further comprising setting a length of the timer depending on an uncertainty of the first clock-time or an uncertainty of the external source.

15. The method of any of the clauses 12 to 14, further comprising setting a clock to an energy mode depending on an energy level.

16. The method of any of the clauses 12 to 15, further comprising, when the second clock-time can not be acquired from the second external source, requesting the second clock-time from a third external source which is different to the second external source.

17. A computer program product comprising instructions which, when the program is executed by a computer, cause the computer to carry out the method of any of the clauses 12 to 16.

18. An apparatus for keeping time, comprising:
means for running a timer, wherein the timer starts when a first clock-time is acquired from an external source; and
means for requesting a second clock-time from a second external source when the timer expires.

19. A wireless unit configured to:
receive a request for time information from a wireless device; and
transmit a signal to the wireless device, the signal comprising the time information in response to the request for the time information.

20. The wireless unit of clause 19, further configured to transmit the signal comprising time information regardless of a user subscription or an authentication from the wireless device from which the request is received.

21. The wireless unit of any of clauses 19 and 20, wherein the request is received and the signal is transmitted via a wireless connection between the wireless unit and the wireless device.

22. The wireless unit of clause 21, wherein the wireless unit and the wireless device are both wireless access points, APs.

23. The wireless unit of any of clauses 21 and 22, wherein the wireless device is further configured to calculate time delay of the request or the signal.

24. The wireless unit of clause 19, wherein the wireless unit is a cellular network AP and the request is received and the signal is transmitted via a random access channel.

25. A method for transmitting time information, the method comprising:
receiving, by a wireless unit, a request for the time information from a wireless device; and
transmitting, by the wireless unit, a signal to the wireless device, the signal comprising the time information in response to the request of the time information.

26. The method of clause 25, wherein transmitting the signal comprising time information is done regardless of a user subscription or an authentication from the wireless device from which the request is received.

27. The method of any of clauses 25 and 26, wherein the requesting is received and the signal is transmitted via a wireless connection between the wireless unit and the wireless device.

28. The method of clause 27, further comprising calculating, by the wireless device, a time delay of request or signal.

29. A computer program product comprising instructions which, when the program is executed by a computer, cause the computer to carry out the method of any of the clauses 25 to 28.

30. An apparatus for transmitting time information, comprising:
means for receiving a request for time information; and
means for transmitting a signal comprising the time information in response to the request for the time information.

1. A wireless device comprising a processor and an internal clock, the processor configured to:
run a timer using the internal clock, wherein the timer starts when a first clock-time is acquired from an external source; and
when the timer expires, request a second clock-time from a second external source.

2. The wireless device of claim 1, wherein the wireless device further comprises a display which is configured to display a message to a user if no second clock-time can be acquired via a wireless connection or if no wireless connection can be established.

3. The wireless device of claim 1, wherein the wireless device further comprises a battery and the processor is configured to only run the timer when a remaining power of the battery is above a threshold.

4. The wireless device of claim 1, wherein the processor is configured to set a length of the timer depending on an uncertainty of the first clock-time or an uncertainty of the external source.

5. The wireless device of claim 1, wherein the internal clock is a low power clock; or
wherein the wireless device comprises different clocks with different accuracies which are used according to remaining power; or
wherein the internal clock can run in different energy modes.

6. The wireless device of claim 1, wherein the processor is configured to request the second clock-time using a connection to a smartphone, a cellular network, satellite positioning, an internet connection, or other wireless networks.

7. The wireless device of claim 6, wherein the processor is configured to select the connection depending on an environment of the wireless device.

8. The wireless device of claim 1, wherein the wireless device is a smart watch.

9. The wireless device of claim 1, wherein the external source and the second external source are the same external source.

10. The wireless device of claim 1, wherein the external source and the second external source are different external sources.

11. The wireless device of claim 1, wherein the processor is further configured to, when the second clock-time can not be acquired from the second external source, request the second clock-time from a third external source which is different to the second external source.

12. A method for keeping time, the method comprising:
running a timer using an internal clock, wherein the timer starts when a first clock-time is acquired from an external source; and
requesting a second clock-time from a second external source when the timer expires.

13. The method of claim 12, further comprising displaying a message to a user if no second clock-time can be acquired via a wireless connection or if no wireless connection can be established.

14. The method of claim 12, further comprising setting a length of the timer depending on an uncertainty of the first clock-time or an uncertainty of the external source.

15. The method of claim 12, further comprising setting a clock to an energy mode depending on an energy level.

16. The method of claim 12, further comprising, when the second clock-time can not be acquired from the second external source, requesting the second clock-time from a third external source which is different to the second external source.

17. A computer program product comprising instructions which, when the instructions are executed by a computer, cause the computer to carry out the method of claim 12.

18. An apparatus for keeping time, comprising:
means for running a timer, wherein the timer starts when a first clock-time is acquired from an external source; and
means for requesting a second clock-time from a second external source when the timer expires.

19. A wireless unit configured to:
receive a request for time information from a wireless device; and
transmit a signal to the wireless device, the signal comprising the time information in response to the request for the time information.

20. The wireless unit of claim 19, further configured to transmit the signal comprising time information regardless of a user subscription or an authentication from the wireless device from which the request is received.

21. The wireless unit of claim 19, wherein the request is received and the signal is transmitted via a wireless connection between the wireless unit and the wireless device.

22. The wireless unit of claim 19, wherein the wireless unit and the wireless device are both wireless access points, APs.

23. The wireless unit of claim 19, wherein the wireless device is further configured to calculate time delay of the request or the signal.

24. The wireless unit of claim 19, wherein the wireless unit is a cellular network AP and the request is received and the signal is transmitted via a random access channel.

25. A method for transmitting time information, the method comprising:
receiving, by a wireless unit, a request for the time information from a wireless device; and
transmitting, by the wireless unit, a signal to the wireless device, the signal comprising the time information in response to the request of the time information.

26. The method of claim 25, wherein transmitting the signal comprising time information is done regardless of a user subscription or an authentication from the wireless device from which the request is received.

27. The method of claim 25, wherein the request is received and the signal is transmitted via a wireless connection between the wireless unit and the wireless device.

28. The method of claim 27, further comprising calculating, by the wireless device, a time delay of the request or the signal.

29. A computer program product comprising instructions which, when the instructions are executed by a computer, cause the computer to carry out the method of claim 25.

30. An apparatus for transmitting time information, comprising:
means for receiving a request for time information; and
means for transmitting a signal comprising the time information in response to the request for the time information.
